(19) United States
(12) Patent Application Publication
(10) Pub. No.: US 2024/0292978 A1
(43) Pub. Date: Sep. 5, 2024

(54) HANDHELD APPLIANCE

(71) Applicant: StoreBound LLC, New York, NY (US)

(72) Inventors: Qiaoqiao Xu, Shenzhen (CN); Cheng Zhao, Shenzhen (CN); Yiyang Zhang, Shenzhen (CN); Shelby Scott, New York, NY (US); Evan Marc Dash, New York, NY (US); Ethan P. Kudler, New York, NY (US)

(21) Appl. No.: 18/117,030

(22) Filed: Mar. 3, 2023

(51) Int. Cl. A47J 43/044; A47J 43/07

(52) U.S. Cl. CPC A47J 43/044; A47J 43/0711; A47J 2043/04418; A47J 2043/0744

(57) ABSTRACT

A handheld appliance and a beater attachment therefor. The handheld appliance may include a housing having a cavity with an opening and an electronic component in the cavity. A power cord may be coupled to the electronic component. The handheld appliance may include a cord storage compartment coupled to the housing to close the opening. The cord storage compartment may include a central support portion. The power cord may be configured to be at least partially wrapped around the central support portion. The cord storage compartment may be movable relative to the housing between: (1) a closed position wherein the central support portion is located within the cavity of the housing; and (2) an open position wherein the central support portion protrudes from the housing to allow adjustments to an amount of the power cord that is wrapped around the central support portion.

### BACKGROUND OF THE INVENTION

Professional and home chefs alike continually struggle with reducing countertop clutter and maintaining an aesthetically pleasing kitchen while striving to preserve the functionality of the kitchen. While previous solutions have addressed problems with storing accessories associated with handheld mixers, consumers are still plagued by issues regarding the power cord. Although cordless handheld appliances have been produced, they lack the power of their corded counterparts. Thus, there is a need in the industry for a handheld appliance that allows for reduced clutter, improved functionality, and better cord storage capabilities. Furthermore, there is a need in the art for an improved beater design to allow for a smoother and more efficient mixing process.

### BRIEF SUMMARY OF THE INVENTION

In one aspect, the invention may be a handheld appliance comprising a housing comprising a cavity and an opening that provides a passageway into the cavity, one or more electronic components located within the cavity of the housing, a power cord operably coupled to the one or more electronic components, and a cord storage compartment coupled to the housing. The cord storage compartment comprises a central support portion, wherein the power cord is configured to be at least partially wrapped around the central support portion; and wherein the cord storage compartment is movable relative to the housing between: (1) a closed position wherein the central support portion is located within the cavity of the housing; and (2) an open position wherein the central support portion protrudes from the housing to allow adjustments to an amount of the power cord that is wrapped around the central support portion.

In another aspect, the invention may be a handheld appliance comprising: a housing comprising a cavity and an opening that provides a passageway into the cavity; one or more electronic components located within the cavity of the housing; a power cord operably coupled to the one or more electronic components, the power cord being configured to transmit power from a power source to the one or more electronic components; a cord storage compartment coupled to the housing and closing the opening, wherein the power cord is capable of being wrapped around the cord storage compartment; wherein the cord storage compartment is movable relative to the housing between: (1) a closed position wherein portions of the power cord that are wrapped around the cord storage compartment are inaccessible to a user; and (2) an open position wherein the portions of the power cord that are wrapped around the cord storage compartment are accessible to the user.

In yet another aspect, the invention may be a beater attachment for a mixer apparatus, the beater attachment comprising: a shaft comprising a first end configured for attachment to the mixer apparatus, a second end opposite the first end, and a longitudinal axis; and a mixing element coupled to the second end of the shaft, the mixing element comprising a bottom end, a top end, and a plurality of arms extending between the bottom and top ends and surrounding the longitudinal axis in a circumferentially spaced apart manner, each of the plurality of arms comprising: a first linear portion extending along a first axis; and a second linear portion extending from the first linear portion along a second axis that is angled relative to the first axis, the first and second linear portions being connected at an apex; and wherein the apexes of the plurality of arms face the same circumferential direction.

In another aspect, the invention may be a beater attachment for a mixer apparatus, the beater attachment comprising: a shaft comprising a first end configured for attachment to the mixer apparatus, a second end opposite the first end, and a longitudinal axis; and a mixing element coupled to the second end of the shaft, the mixing element comprising a bottom end, a top end, and a plurality of arms extending between the bottom and top ends and surrounding the longitudinal axis in a circumferentially spaced apart manner, each of the plurality of arms comprising: a first linear portion extending along a first axis; and a second linear portion extending from the first linear portion along a second axis that is angled relative to the first axis, the first and second linear portions being connected at an apex; and wherein each of the plurality of arms has a wedge-shaped transverse cross-sectional area.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a handheld appliance kit in accordance with an embodiment of the present invention.

FIG. 2 is an exploded view of the handheld appliance kit of FIG. 1.

FIG. 3A is a perspective view of a handheld appliance in accordance with an embodiment of the present invention with a cord storage compartment in a closed position.

FIG. 3B is a bottom rear perspective view of the handheld appliance of FIG. 3A.

FIG. 4 is an exploded view of the handheld appliance of FIG. 3B illustrating the cord storage compartment thereof separated from a housing thereof.

FIG. 5 is a partial bottom perspective view of the housing of the handheld appliance of FIG. 3A.

FIG. 6A is a perspective view of the cord storage compartment of the handheld appliance of FIG. 3A in accordance with an embodiment of the present invention.

FIG. 6B is a top view of the cord storage compartment of FIG. 9A.

FIG. 6C is a cross section view of the cord storage compartment taken along line VI-VI of FIG. 6B.

FIG. 7A is a side view of the handheld appliance of FIG. 3A.

FIG. 7B is a cross section view of the handheld appliance taken along line VII-VII of FIG. 7A.

FIG. 8A is a side view of the handheld appliance of FIG. 3A with the cord storage compartment in an open position.

FIG. 8B is a cross section view of the handheld appliance taken along line VIII-VIII of FIG. 6A.

FIG. 9 is a side view of the handheld appliance with the cord storage compartment in the open position and with the power cord not wrapped around the central support portion.

FIG. 10 is a perspective view of a handheld appliance with two attachments in accordance with an embodiment of the present invention.

FIG. 11 is a perspective view of a beater attachment in accordance with an embodiment of the present invention.

FIG. 12 is a side view of the beater attachment of FIG. 11.

FIG. 13 is a top view of the beater attachment of FIG. 11.

FIG. 14 is a bottom view of the beater attachment of FIG. 11.

FIG. 15A is a cross-sectional view taken along line XVA-XVA of FIG. 12.

FIG. 15B is a close-up view of area XVB-XVB of FIG. 15A.

### DETAILED DESCRIPTION OF THE INVENTION

The following description of the preferred embodiment(s) is merely exemplary in nature and is in no way intended to limit the invention, its application, or uses. The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper.” “horizontal,” “vertical,” “above.” “below,” “up.” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used herein, the term “or” is to be interpreted as a logical operator that results in true whenever one or more of its operands are true. Furthermore, the term “substantially parallel” should be construed to refer to an orientation that is 0 to 5 degrees off from parallel.

Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

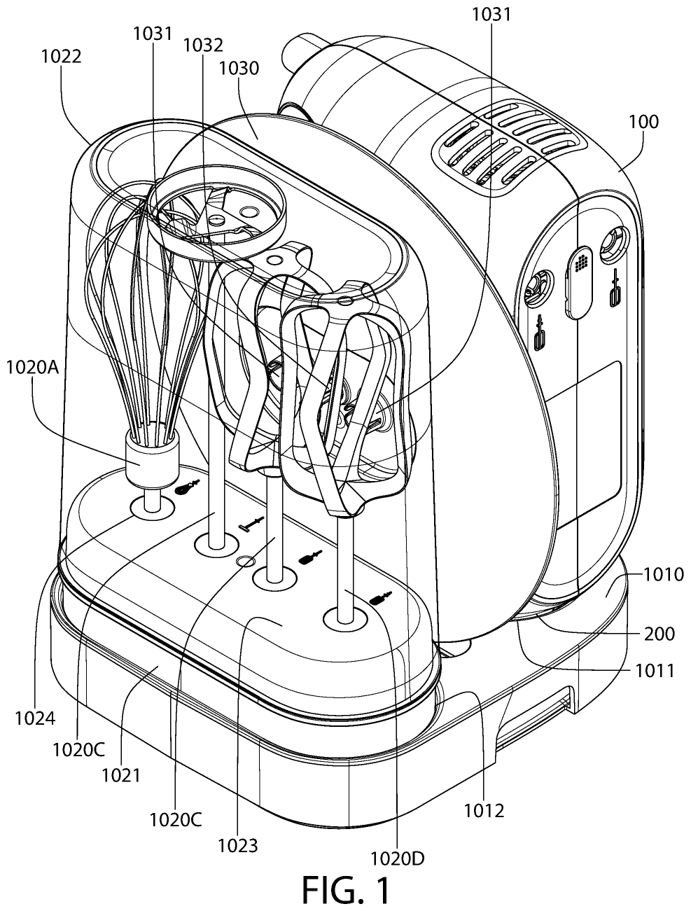

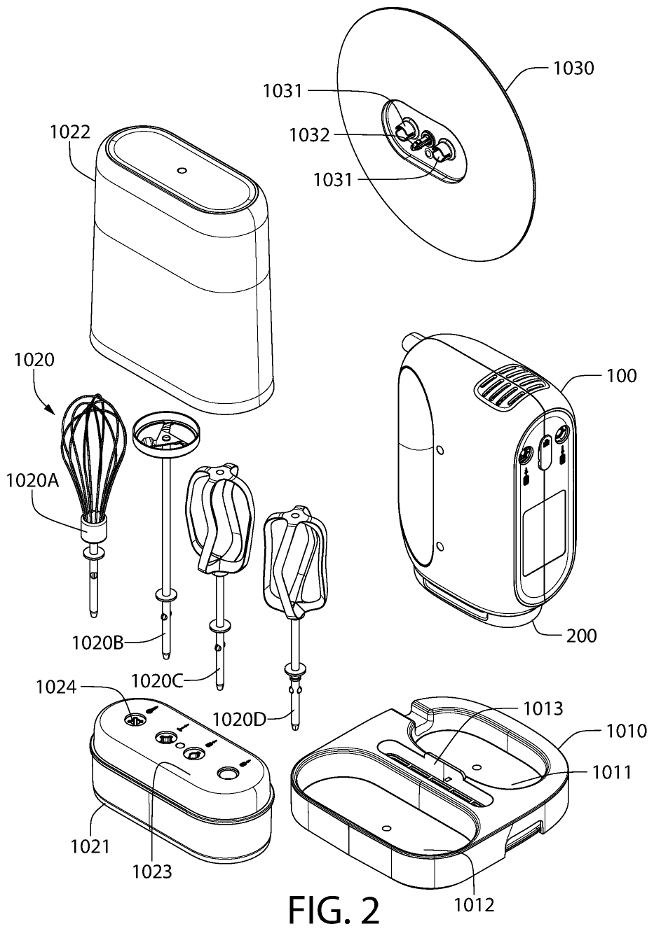

Referring to FIGS. 1 and 2, a handheld appliance kit 1000 will be described in accordance with an embodiment of the present invention. The handheld appliance kit 1000 may comprise a handheld appliance 100, a base component 1010, an attachment base component 1021, an attachment cover 1022, a splashguard 1030, and at least one attachment 1020.

In the exemplified embodiment, the handheld appliance 100 is a hand mixer. However, the invention is not to be so limited and certain inventive features described herein may be applied to alternative types of handheld appliances which include a plug for attachment to a wall outlet, such as for example without limitation irons, handheld vacuum devices, and the like. Moreover, some of the inventive concepts described herein may be applicable to devices other than handheld devices, including any device which includes a power cord. Examples of such devices include, without limitation, lamps and other lighting devices, vacuum cleaners, chargers, small appliance cooking devices, and the like.

In the exemplified embodiment, the at least one attachment 1020 comprises four attachments 1020a, 1020b, 1020c, 1020d. In the exemplified embodiment, the first attachment 1020a is a whisk, the second attachment 1020b is a milkshake rod, and the third and fourth attachments 1020c, 1020d are beaters. Additional attachments may be included as part of the handheld appliance kit 1000 in other embodiments. The handheld appliance kit 1000 may be sold with more or fewer than four attachments in various embodiments. Each of the attachments 1020a-d is configured to be operably coupled to the handheld appliance 100 to facilitate the performance of a desired function therewith. In the exemplary embodiment, the handheld appliance 100 is a hand mixer, and thus each of the attachments 1020a-d is configured to be detachably coupled to the hand mixer, which in turn causes the attachments 1020a-d to rotate to perform a desired function (mixing ingredients, for example).

As noted above, the handheld appliance kit 1000 may comprise the attachment base component 1021. The attachment base component 1021 may comprise an upper surface 1023 having one or more holes 1024 formed therein. Each of the attachments 1020a-d may comprise a shaft that is configured to be inserted into one of the holes 1024 of the base component 1021 for storage of the attachments 1020a-d in an upright orientation. The attachments 1020a-d may be detachably coupled to the attachment base component 1021 so that each of the attachments 1020a-d may be independently removed from the attachment base component 1021 for use with the handheld appliance 100. In the exemplified embodiment, the attachment base component 1021 comprises four of the holes 1024, one corresponding with each of the attachments 1020a-d. The attachment cover 1022 may be coupled to the attachment base component 1021 (or directly to the base component 1010). The attachment cover 1022 may define an internal cavity within which any of the attachments 1020a-d that are being supported by the attachment base component 1021 may nest when the attachment cover 1022 is coupled to the attachment base component 1021. The attachment cover 1022 may be transparent so that the attachments 1020a-d are visible therethrough, although the invention is not limited to this in all embodiments and various degrees of transparency, translucency, opaqueness, and color selections may be used for the attachment cover 1022 in different embodiments.

In some embodiments, the handheld appliance kit 1000 may comprise the splashguard 1030. The splashguard 1030 may be transparent or colored. The splashguard 1030 may be configured for attachment to the handheld appliance 100. The splashguard 1030 may comprise a post 1032 that is configured to mate with a hole on the handheld appliance 100 to facilitate the connection between the splashguard 1030 and the handheld appliance 100. Other connection techniques may be used in other embodiments, including having a post on the handheld appliance 100 that mates with an opening on the splashguard 1030, hook and loop fasteners, mechanical attachments, friction fit components, snap fit components, latches, or the like. The splashguard 1030 may comprise a pair of openings 1031 that enable shafts of the attachments 1020a-d to extend therethrough so that the attachments 1020a-d may be coupled to the handheld appliance 100 with the splashguard 1030 positioned between the attachments 1020a-d and the handheld appliance 100. In this way, the splashguard 1030 may prevent fluids and other materials that are being mixed with the handheld appliance 100 from entering into an interior of the handheld appliance 100 where the electronics thereof are located.

The base component 1010 may form a storage base that holds the other components of the handheld appliance kit 1000. The base component 1010 may comprise a first well 1011, a second well 1012, and a third well 1012. The first well 1011 may be configured to receive at least a portion of the handheld mixer 100 to support the handheld mixer 100 for storage. The second well 1012 may be configured to receive the attachment base component 1021 (or a portion thereof) to support the attachment base component 1021 (and the attachments 1020a-d) for storage. The third well 1013 may be configured to receive the splashguard 1030 to support the splashguard 1030 for storage. FIG. 1 illustrates the handheld appliance kit 1000 with all components in their storage state. This allows the handheld appliance kit 1000 to take up little space in cabinets and/or on countertops when not in use while keeping all components thereof together so that they can be easily found when needed for use.

The handheld appliance kit 1000 may include any of the components described herein, and need not include all components in all embodiments. Thus, for example, the splashguard 1030 may be omitted in some embodiments. Various ones of the attachments 1020a-d may be omitted in some embodiments or replaced with other types of attachments, such as dough hooks or the like. Furthermore, depending on the type of handheld appliance included as part of the kit, the attachments may be changed (for example, if the handheld appliance were a vacuum, then vacuum attachments would be used instead of mixer attachments). Moreover, the attachment cover 1022 may be an optional component. In one embodiment, a single cover may be included, which surrounds all components of the kit 1000, including the attachments 1020a-d, the splashguard 1030, and the handheld appliance 100.

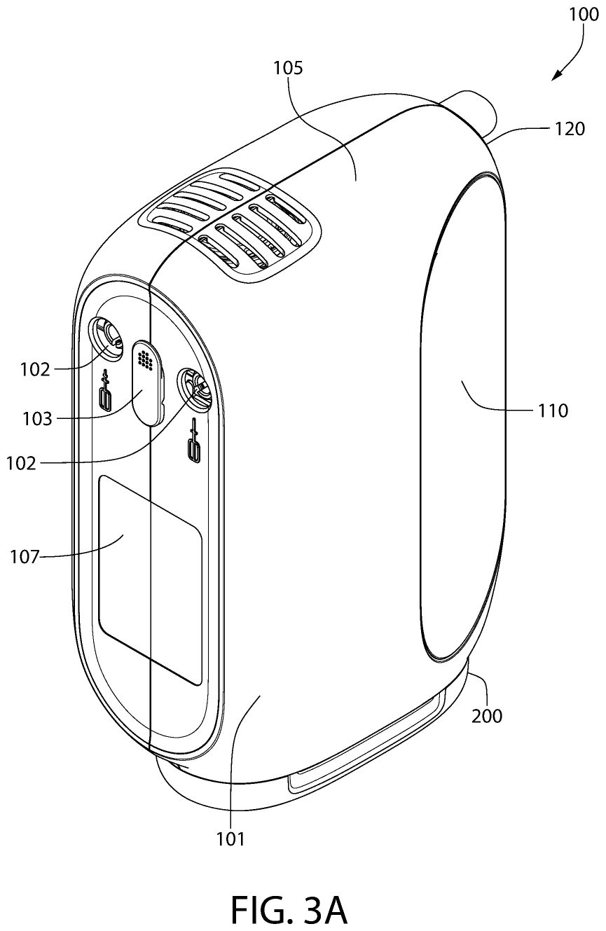

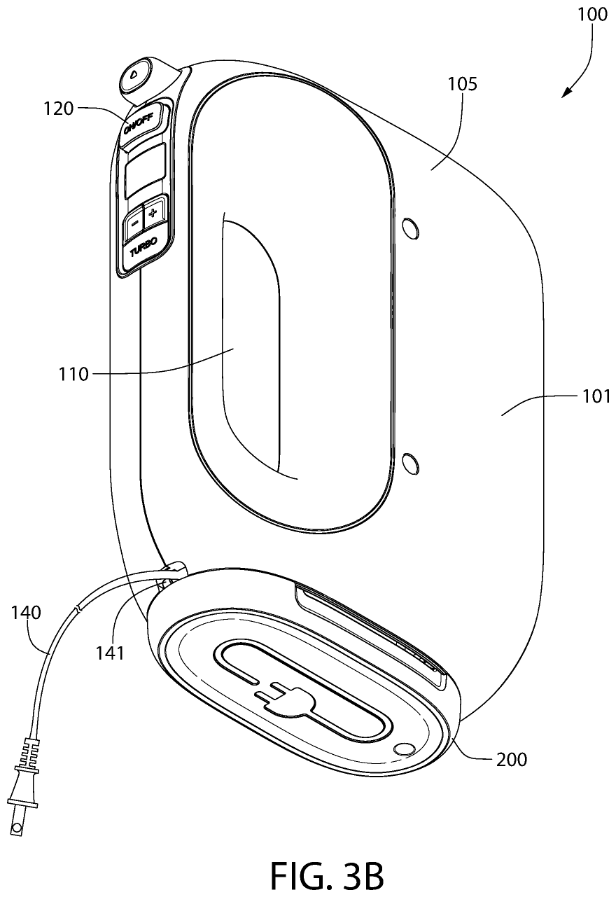

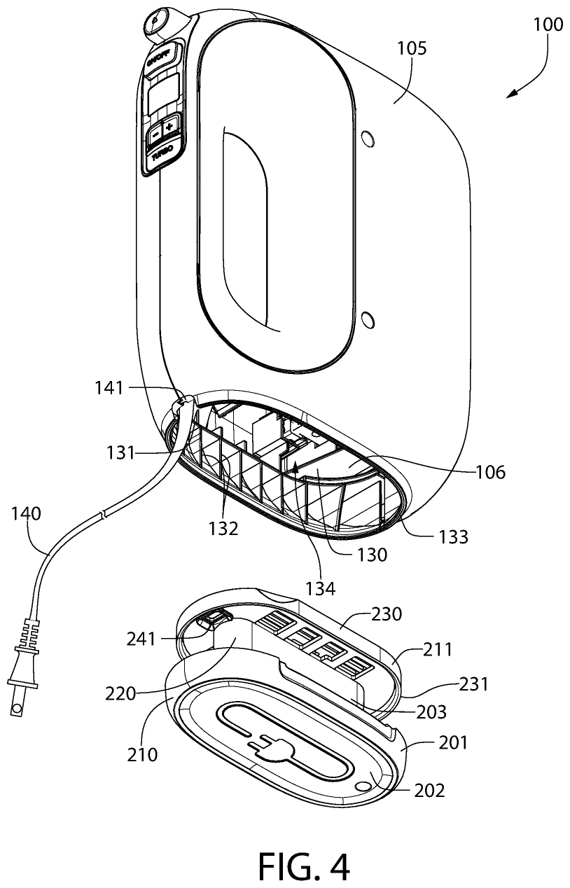

Referring to FIGS. 3A, 3B, and 4, the handheld appliance 100 will be described in accordance with an embodiment of the present invention. The handheld appliance 100 may generally comprise a housing 101 and a cord storage compartment 200 that is operably coupled to the housing 101. As described in detail below, the cord storage component 200 may be movable (slidable, translatable, pivotable, rotatable, or the like in different embodiments) relative to the housing 101. The handheld appliance 140 may include a power cord or electric cord 140. The power cord 140 may be partially or fully wrapped around the cord storage compartment 200 to maintain organization and prevent the power cord 140 from impeding use of the handheld appliance 100. The cord storage compartment 200 may be moved relative to the housing 100 to provide a user with access to the power cord 140 so that the user can control or modify the amount of the power cord 140 which protrudes from the housing 100 (with the remainder of the power cord 140 being wrapped around the cord storage compartment 200). The function and operation of the cord storage compartment 200 will be described in greater detail below.

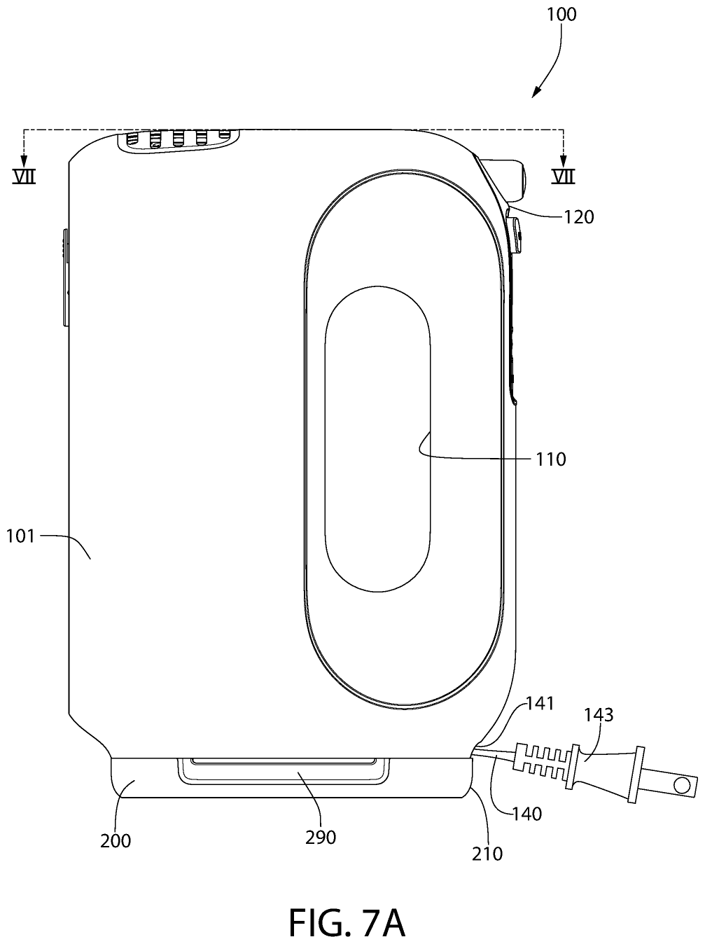

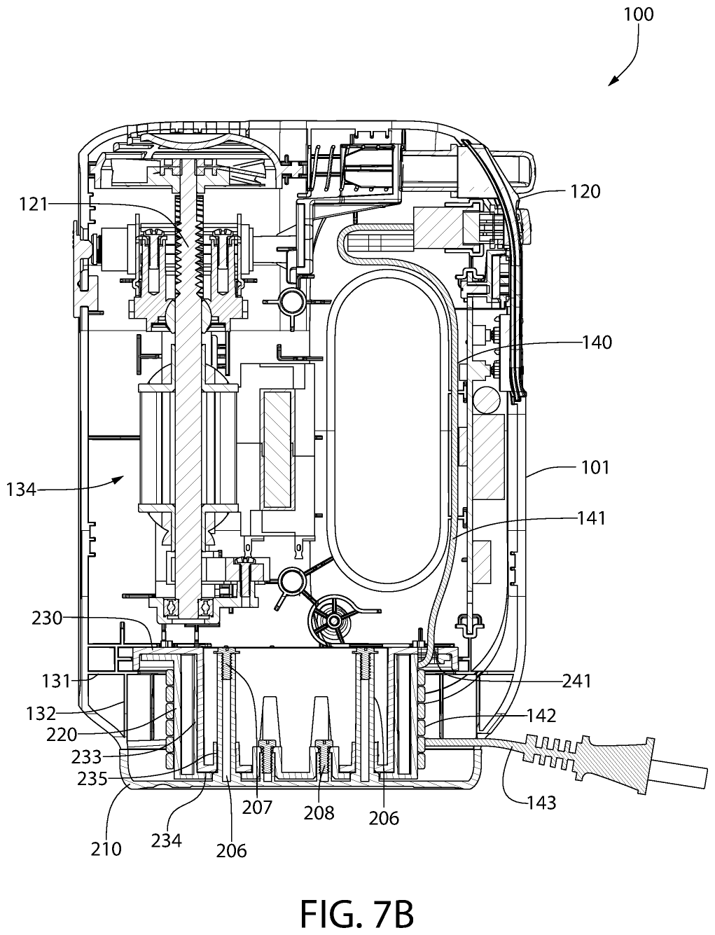

The housing 101 may comprise an outer surface 105 and an inner surface 106. The inner surface 106 may define a cavity 134 within which electronic components 121 (see FIG. 7B, for example) of the handheld appliance 100 may be located. The electronic components 121 may include one or more of a processor, a controller, a motor, a memory, illumination elements, sensors, and other electronic devices and circuitry necessary for the proper operation of the handheld appliance 100. Thus, depending on the specific type of device used as the handheld appliance 100, the specific electronic components located within the cavity 134 may be modified. In accordance with the exemplified embodiment whereby the handheld appliance 100 is a hand mixer, the electronic components 121 may generally comprise the components listed above. The power cord 140 may be operably coupled to the one or more electronic components and configured to transmit power from an external power source to the one or more electronic component to facilitate operation of the handheld appliance 1000.

The handheld appliance 100 may comprise a user interface 120 located on its outer surface 105. The user interface 105 may comprise a power button (or ON/OFF button), a dial, various actuators to control different parameters of the handheld appliance 100 in accordance with its function, a display screen, and the like. A user may actuate the power button to power the handheld appliance 100 on and off. The power cord 140 may be required to be plugged into a power outlet prior to actuation of the power button to facilitate the powering on of the device. That is, the handheld appliance 100 may not include an internal power source such as a battery, but may instead rely on external power from a power outlet.

The handheld appliance 100 may further comprise a handle 110. The handle 110 may comprise an aperture formed through the housing 101, which is sufficiently large so that several of the user's fingers may extend through the aperture as the user grips the handle 110. Of course, other handles may be used, including having a lever style handle protruding from the housing 101 rather than having an aperture.

As best seen in FIG. 3A, in accordance with the exemplified embodiment the outer surface 105 of the handheld appliance 100 may comprise a working surface portion 107. The working surface portion 107 may be the portion of the handheld appliance 100 that either directly, or through attachments coupled thereto, performs its intended function. In the exemplified embodiment, the handheld appliance 100 is a hand mixer. Thus, in the exemplified embodiment the working surface portion 107 comprises at least one opening 102. More specifically, in the exemplified embodiment the working surface portion 107 comprises a pair of the openings 102, although the exact number of the openings 102 may be less than or more than two in different embodiments. Each of the openings 102 may be configured to receive at least one of the attachments 1020 described above. Specifically, a stem or shaft of the attachments 1020 may be configured to be inserted into the openings 102, which may facilitate a detachable connection between the attachment 1020 and the housing 101. The attachments 1020 may be coupled to the housing 101 through a friction fit and may be locked thereto simply by press-fitting the shafts of the attachments 1020 into the openings 102. In other embodiments, additional steps may be required to lock the attachments 1020 to the housing 101, such as actuating a lock mechanism or the like. The attachments 1020 may be capable of being detached from the housing 101 by a user applying a pulling force onto the attachments 1020 relative to the housing 101. Other techniques may be used as well.

In some embodiments, the housing 101 comprises a third opening configured to allow the housing 101 to be coupled to the splashguard 1030. As noted above, the splashguard may comprise a post 1032 that is configured to mate with the third opening. In the exemplified embodiment, the handheld appliance 100 comprises a closure member 103 coupled to the housing 101 and configured to close the third opening when the splashguard 1030 is not coupled to the housing 101. Thus the third opening is not visible in FIG. 3A because it is closed and covered by the closure member 103. The closure member 103 may be a resilient flap formed from an elastomeric material with a nub that engages the third opening to hold the closure member 103 into position. A user may easily remove the nub from the third opening and pivot the closure member 103 relative to the housing 101 to expose the third opening and allow for connection of the splashguard 1030 thereto. As noted above, other features may be used instead of the third opening for coupling the splashguard 1030 to the housing 101 and thus certain of these features may be omitted.

The housing 101 may include a notch 141 to allow the power cord 140 to protrude from the housing 101 even when the cord storage compartment 200 is in a closed state such as shown in FIG. 3B. While the term notch is used herein, the notch 141 could also be an opening, aperture, slit, or some other structure that would allow the power cord 140 to pass therethrough so that the power cord 140 may extend or protrude from the housing 101 for engagement with an electrical outlet. In some embodiments, the notch 141 may be formed partially by a portion of the housing 101 and partially by a portion of the cord storage compartment 200. In other embodiments, the notch 141 may be formed solely by the cord storage compartment 200 rather than the housing 101.

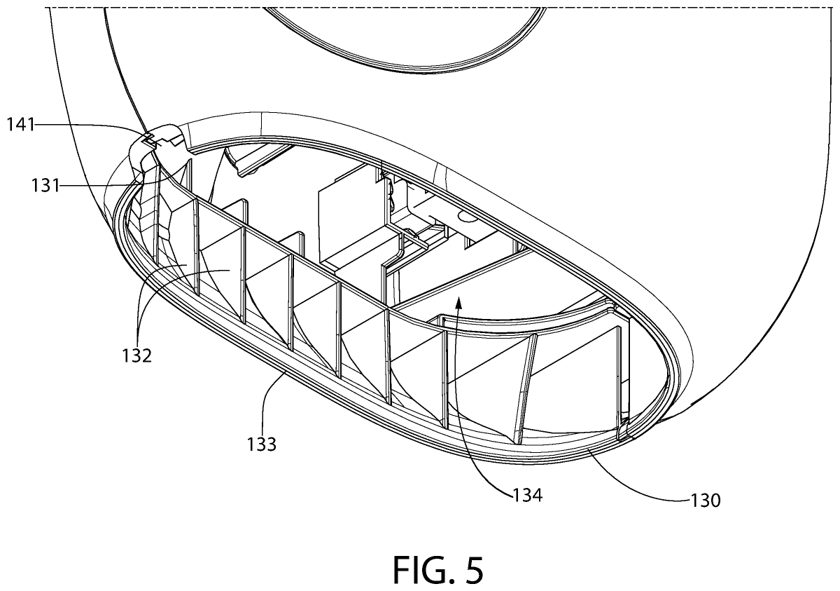

Referring to FIGS. 4 and 5, the handheld appliance 1000 will be further described. FIG. 4 is an exploded view illustrating the cord storage component 200 separated entirely from the housing 101 and FIG. 5 is a close-up view of a portion of the housing 101. As seen, the housing 101 comprises an opening 130 that provides a passageway into the cavity 134. The opening 130 may be formed through a bottom surface portion of the housing 101. The housing 101 may comprise an exterior rim 133 that defines and surrounds the opening 130. The housing 101 may further comprise an inset interior rim 131 that is recessed relative to the exterior rim 133 and located within the cavity 134 of the housing 101. In some embodiments, there may be one or more support structures 132 such as ribs or fins or the like located between the exterior rim 133 and the interior rim 131. Such support structures 132 may provide structural integrity to the interior rim 131, which may be desirable because the interior rim 131 may support portions of the cord storage compartment 200, as described further below.

The cord storage compartment 200 may generally comprise a cover plate 205 and a fixed component 230. The cover plate 205 may comprise a front cover 210 and a central support portion 220. When the cord storage compartment 200 is coupled to the housing 101, the fixed component 230 may be fixed to the housing 101 and positioned entirely within the cavity 134 of the housing 101. The fixed component 230 may comprise a lower edge 231 that rests atop of the interior rim 131 to hold the fixed component 230 in place within the housing 101. The fixed component 240 may be further attached to the housing 101 using fasteners such as screws or using other structural features of the housing 101 and the fixed component 140. The front cover 210 and the central support portion 220 may be coupled together to form the cover plate 205. The front cover 210 and the central support portion 220 may be collectively movable relative to the housing 101 and to the fixed component 230, which is fixed to the housing 101 as described herein.

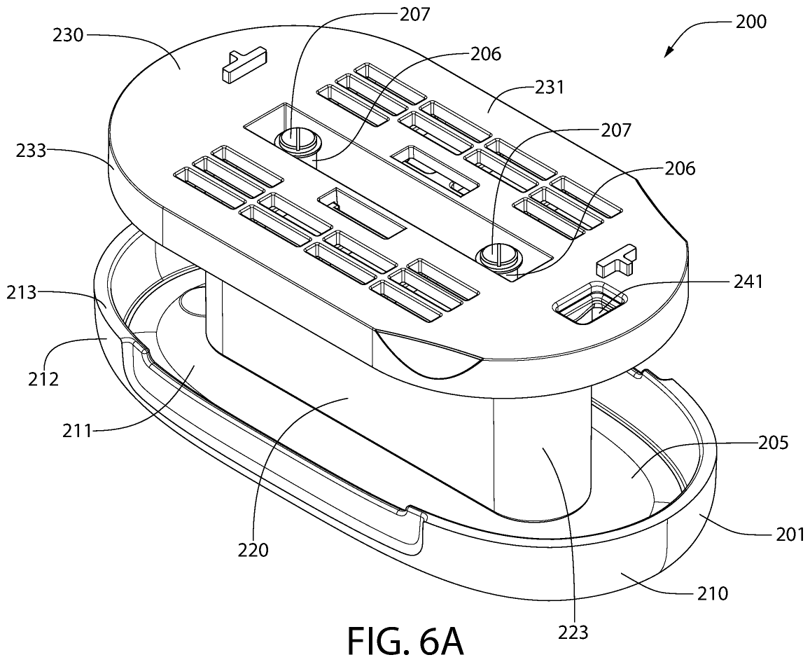

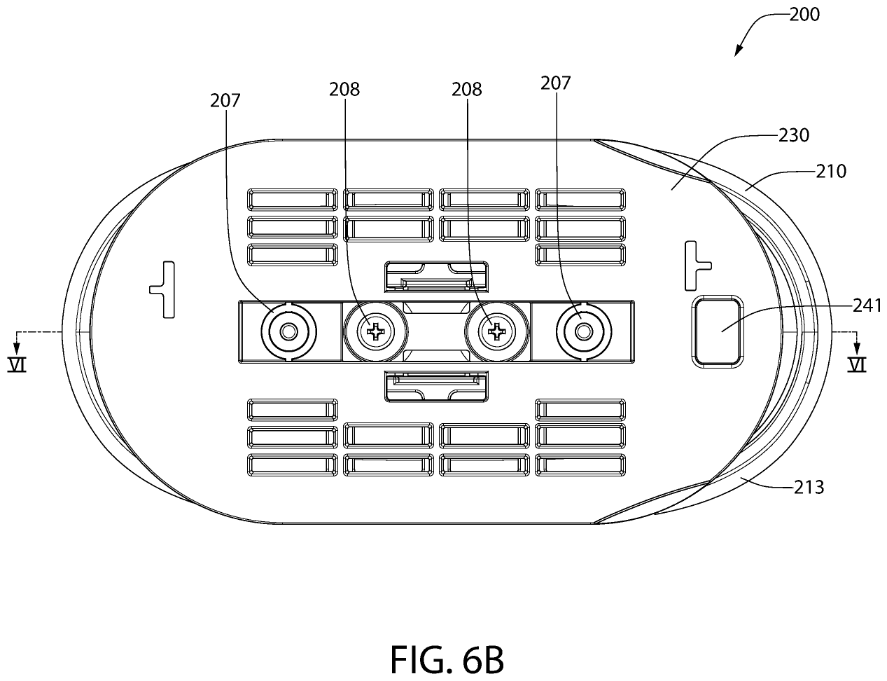

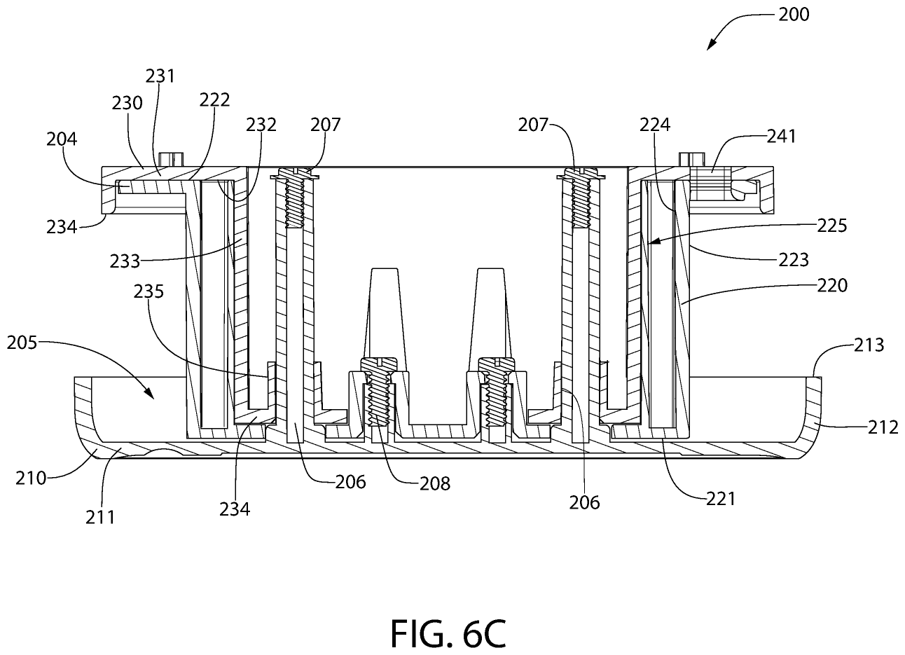

Referring to FIGS. 6A-6C, the cord storage compartment 200 will be further described. The central support portion 220 comprises a first end 221, a second end 222, and an outer surface 223 upon which the power cord is configured to be wrapped. The central support portion 220 further comprises an inner surface 224 opposite the outer surface 223. The inner surface 224 may define an interior space 225. The central support portion 220 may have an oval shape, although the invention is not to be so limited in all embodiments. The front cover 210 may be coupled to the central support portion 220 at or adjacent to the first end 221 of the central support portion 220. The fixed component 230 may be coupled to the central support portion 220 at or adjacent to the second end 222 of the central support portion. Each of the front cover 210 and the fixed component 230 may protrude radially beyond the outer surface 223 of the central support portion 220.

In the exemplified embodiment, the front cover 210 is coupled to the central support portion 220 using one or more fasteners 208, such as screws or the like. In other embodiments, the front cover 210 and the central support portion 220 may be coupled together by mechanical means, such as interlocking features of the front cover 210 and the central support portion 220. In still other embodiments, the front cover 210 and the central support portion 220 may be formed as an integral, monolithic component. Thus, the front cover 210 and central support portion 220 need not be two distinct components in all embodiments.

The front cover 210 may comprise a floor portion 211 and a sidewall 212 that extends from the floor portion 211 to a distal end 213. The distal end 213 of the sidewall 212 of the front cover 210 may engage the exterior rim 133 of the housing 101 to form an interface when the cord storage compartment 200 is in a closed state as described below. The front cover 210 may further comprises at least one post 206 protruding from the floor portion 211 at a position that is radially inward of the sidewall 212. In the exemplified embodiment, the front cover 210 comprises two of the posts 206, although the invention is not to be limited by the specific number of posts 206 shown in the drawings. When the cover plate 205 is assembled, the post 206 may be located within the interior space 225 of the central support portion 220. The post 206 may terminate in a post flange 207. In the exemplified embodiment, the post flange 207 is formed by a head of a screw, which is coupled to the post 206. In other embodiments, the post 206 may comprise an integral flange.

The fixed component 230 may comprise a plate portion 231 having a lower surface 232, a sidewall portion 233 extending from the lower surface 232 of the plate portion 231 to a distal end 234, and a flange portion 235 protruding inwardly from the distal end 234 of the sidewall portion 233. The flange portion 235 may comprise one or more openings 236 formed therethrough. As best seen in FIG. 6C, the posts 206 of the front cover 210 may extend through the openings 236 in the flange portion 235 of the fixed component 230. In some embodiments, this is why the post flanges 207 are formed from screws that are coupled to the distal ends of the posts 206. Specifically, the posts 206, due in part to not having integral flanges, are able to be inserted through the openings 236 in the flange portion 235 of the fixed component 230 during assembly of the cord storage compartment 200. The screws are then attached to the distal ends of the posts 206 to form the post flanges 207. The post flanges 207 formed by the screws then prevents the front cover 210 (and more specifically the cover plate 205) from becoming completely detached from the fixed component 230.

That is, with the cord storage compartment 200 is assembled as shown in FIG. 6C, the cover plate 205 comprising the front cover 210 and the central support portion 220 is capable of moving vertically downwardly relative to the fixed component 210 until the post flanges 207 abut against the flange portion 235 of the fixed component 230. Thus, the post flanges 207 of the cover plate 205, and the flange 235 and its structural features of the fixed component 230, form stopper features that engage each other to prevent the cover plate 205 from becoming detached from the fixed component 230. Thus, with the fixed component 230 fixed to the housing 101, the cover plate 205 is able to move vertically downwardly until the stopper features engage each other (open state or open position of the cord storage compartment 200) and then move vertically upwardly into the position shown in FIG. 6C (closed state or closed position of the cord storage compartment 200).

In the exemplified embodiment, the plate portion 231 of the fixed component 230 further comprises an opening 241 extending from a top surface of the plate portion 231 to a bottom surface of the plate portion 231. The opening 241 is configured to allow portions of the power cord 140 to extend from the cavity 234 of the housing 101 and into a space of the cord storage compartment 200 located between the front cover 210 and the fixed component 230. The portions of the power cord 240 that extend through the opening 241 may be wrapped around the outer surface 223 of the central support portion 220 of the cord storage compartment. A user may determine how much of the power cord 140 to wrap around the central support portion 220, which may be dictated by how far away the handheld appliance 100 is being used relative to an electrical outlet.

As noted above, the cord storage compartment 200 is configured to be movable from a closed position to an open position. When in the closed position, a distal end 204 of the central support portion 230 is in contact with the lower surface 232 of the plate portion 231 of the fixed component 230. In the closed position, the cord storage compartment 200 may form an interface with the housing 101. More specifically, the distal end 213 of the sidewall 212 of the front cover 210 of the cover plate 205 may form an interface with the exterior rim 133 of the housing 101. When in an open position, the post flange 207 may contact the flange portion 235 of the fixed component 230 to form a stopper feature to prevent detachment of the cover plate 205 from the fixed component 230. In some embodiments, the distal end 204 of the central support portion 230 may form an interface with the housing 101 to prevent access to the cavity 134 of the housing 101. Furthermore, the central support portion 220 may protrude from the housing 101 when the cord storage compartment 200 is in the open position to allow adjustments to an amount of the power cord 140 that is wrapped around the central support portion 220.

FIG. 7A is a front view of the handheld appliance 100 with the cord storage compartment 200 in the closed position. FIG. 7B is a cross-sectional view taken along line VII-VII of FIG. 7A. As noted above, the fixed component 230 of the cord storage component 200 is engaged with the interior rim 131 of the housing 101 to fix the fixed component 230 in place relative to the housing 101. Additional fasteners may be used to secure the fixed component 230 to the housing 101, such as screws, bolts, or the like which may extend through the fixed component 230 and into a wall or feature of the housing 101. The power cord 140 comprises a first portion 141 located within the cavity 134 of the housing 101, a second portion 142 that is at least partially wrapped around the central support portion 220 of the cord storage compartment 200, and a third portion 143 that protrudes from the housing 100 to the exterior environment. The third portion 143 of the power cord 140 comprises the plug, which is configured to engage an electrical outlet to supply power to the electronic components 121 of the handheld appliance 100.

The cord storage component 200 may be maintained in the closed position until an external force pulls the cord storage component 200 relative to the housing 101. The cord storage component 200 may be maintained in the closed position due to friction, tight fit, or the like between the components of the cord storage component 200 as described above. The cord storage compartment 200 may be altered into the open state and then the power cord 140 may be partially or fully unwound from the central support portion 220 depending on the length of the power cord 140 needed to reach the electrical outlet

When the cord storage compartment 200 is in the closed position, the central support portion 220 thereof is at least partially located within the cavity 134 of the housing 101. The central support portion 220 of the cord storage compartment 200 and any portion of the power cord 140 wrapped there-around is hidden from view when the cord storage compartment 200 is in the closed position.

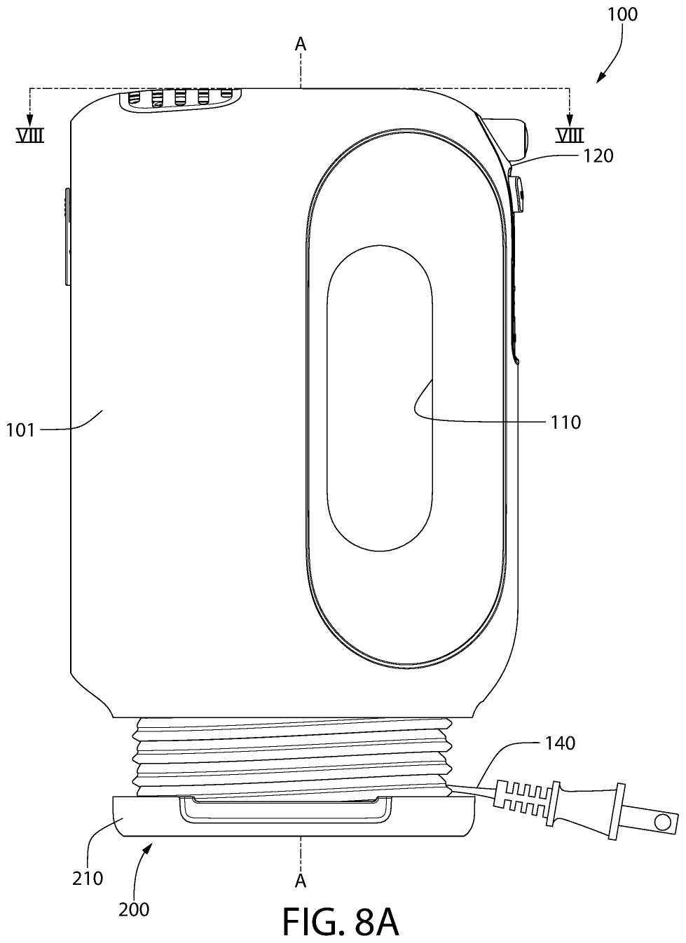

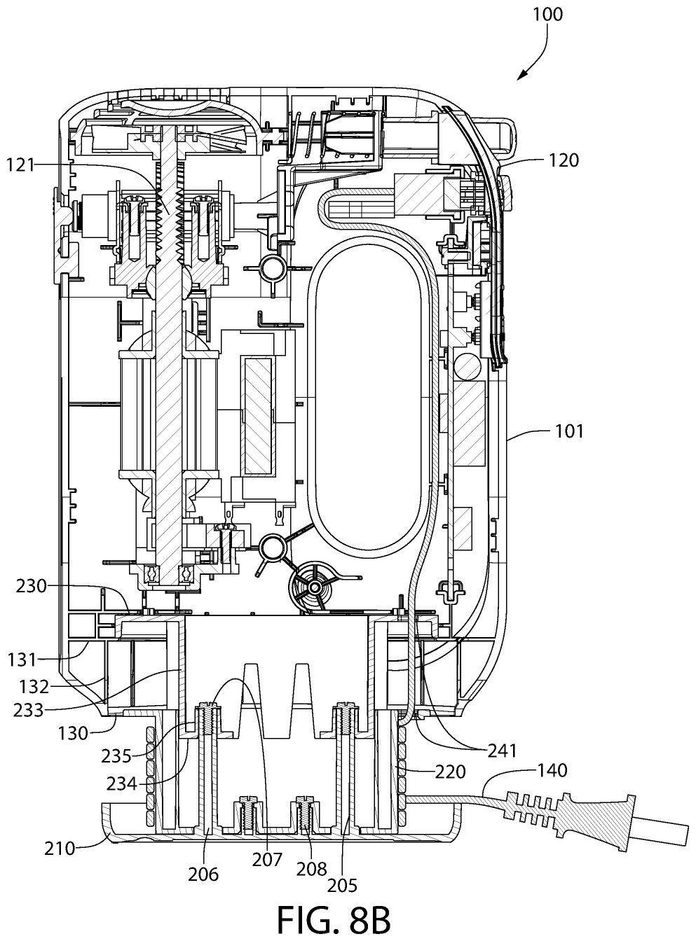

Turning to FIGS. 8A and 8B, the handheld appliance 100 is illustrated with the cord storage compartment 200 in the open position. To alter the cord storage compartment 200 from the closed position shown in FIGS. 7A and 7B to the open position shown in FIGS. 8A and 8B, a user pulls the cover plate 205 (or the front cover 210) of the cord storage compartment 200 relative to the housing 100, which causes the cover plate 205 to move or slide axially (in a direction of a longitudinal axis A-A of the handheld appliance 100) relative to the housing 100. As the cord storage compartment 200 moves or slides relative to the housing 100, the central support portion 220 of the cord storage compartment 200 extends or protrudes from the opening 130. The central support portion 220 and the front cover 210 of the cord storage compartment 200 are capable of moving axially relative to the housing 101 until the stopper feature of the cover portion 205 (i.e., the post flange 207) engages the stopper feature of the fixed component 230 (i.e., the flange portion 235). FIGS. 8A and 8B illustrate the cord storage compartment 200 in its fully open position. The cord storage compartment 200 may be in any axial position between the fully open position of FIGS. 8A and 8B and the fully closed position of FIGS. 7A and 7B.

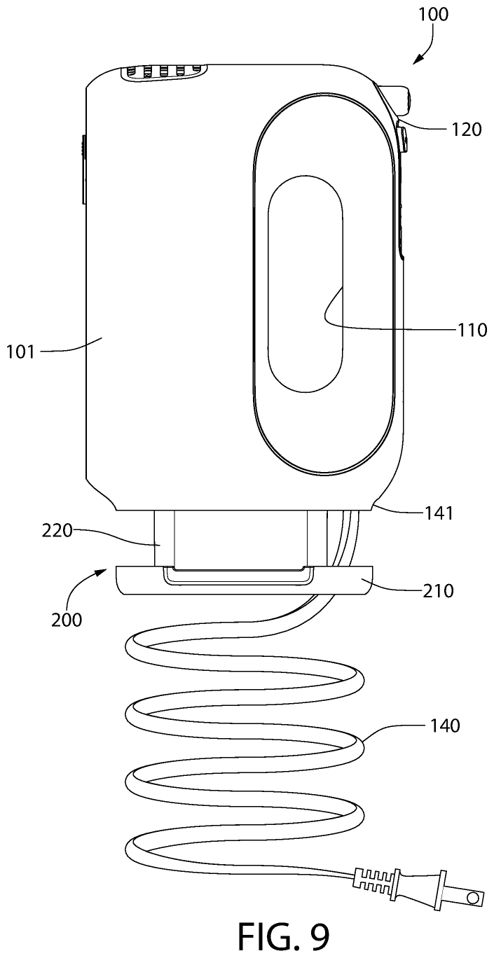

FIG. 9 illustrates the handheld appliance 100 with the cord storage compartment 200 in the open position and with the power cord 140 unwrapped from the cord storage compartment 200. The power cord 140 may be wrapped any number of rotations or loops around the central support portion 220 of the cord storage compartment 200. Regardless of whether the power cord 140 is fully, partially, or not at all wrapped around the central support portion 220 of the cord storage compartment 200, the cord storage compartment 200 can be altered from the open position back to the closed position. Once so altered, the central support portion 220 nests back inside of the cavity 134 of the housing 101 and any portion of the power cord 140 that is not wrapped around the central support portion 220 passes through the notch 141 described above. Thus, a user can easily adjust the length of the portion of the power cord 140 which protrudes from the housing 101 when the cord storage compartment 200 is in the closed state. When the handheld apparatus 100 is in use, perhaps a greater length of the power cord 140 protrudes from the housing 101 so that it can reach an electrical outlet. When the handheld apparatus 100 is not in use, perhaps only the plug of the power cord 140 protrudes from the housing 101 for clean and organized storage. Any portion of the power cord 140, which is wrapped around the central support portion 220 of the cord storage compartment 200, is not visible when the cord storage compartment 200 is in the closed position.

When the cord storage compartment 200 is in the open state, a user has easy access to the cord storage compartment 200, allowing the user to customize the length of the power cord 140. When the cord storage compartment 200 is in the closed state, the power cord 140 is safely out of the way, allowing the user to have a tailored experience when using the handheld appliance 100 and preventing the power cord 140 from getting in the way.

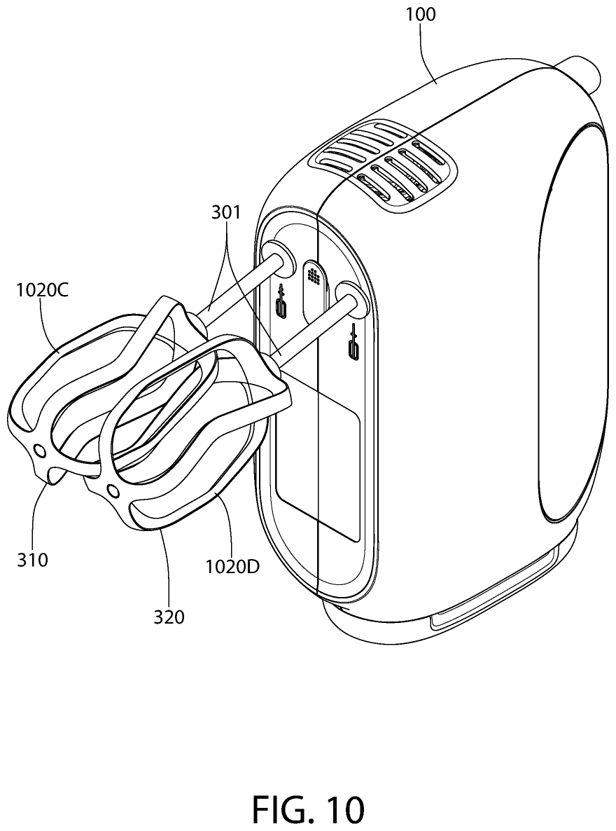

Referring to FIG. 10, an embodiment is illustrated showing the attachments 1020c, 1020d (see FIG. 2) attached to the handheld appliance 100. In this embodiment, each of the attachments 1020c. 1020d is a beater attachment and the handheld appliance 100 is a hand mixer. The attachments 1020c, 1020d can be readily and repeatedly attached to and detached from the handheld appliance 100 using techniques that are well known in the art. Each of the beater attachments 1020c, 1020d comprises a shaft 301 and a mixing element 310, 320. The shafts 301 may be formed from metal and the mixing elements 310, 320 may be formed from a hard plastic material such as nylon. The mixing elements 310, 320 may each be formed as a monolithic and integral structure.

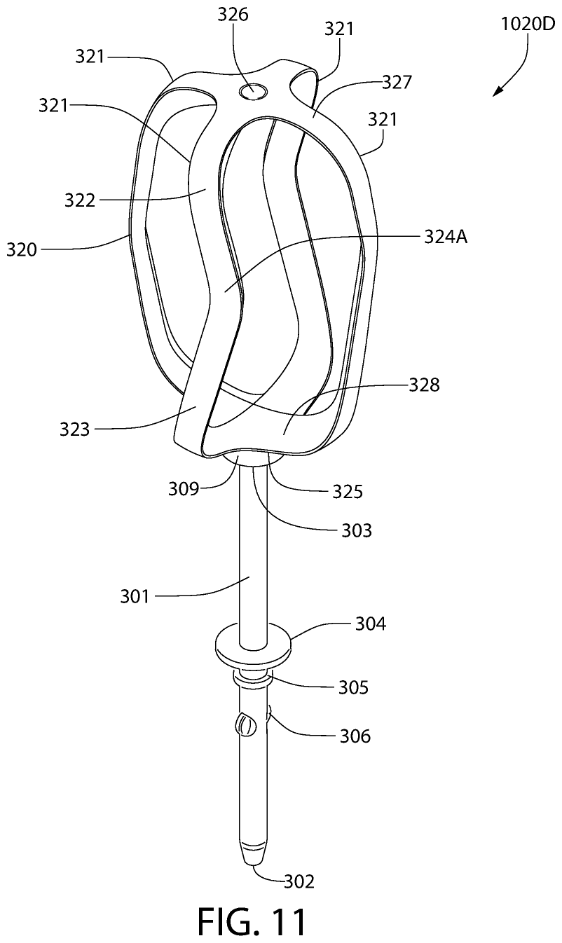

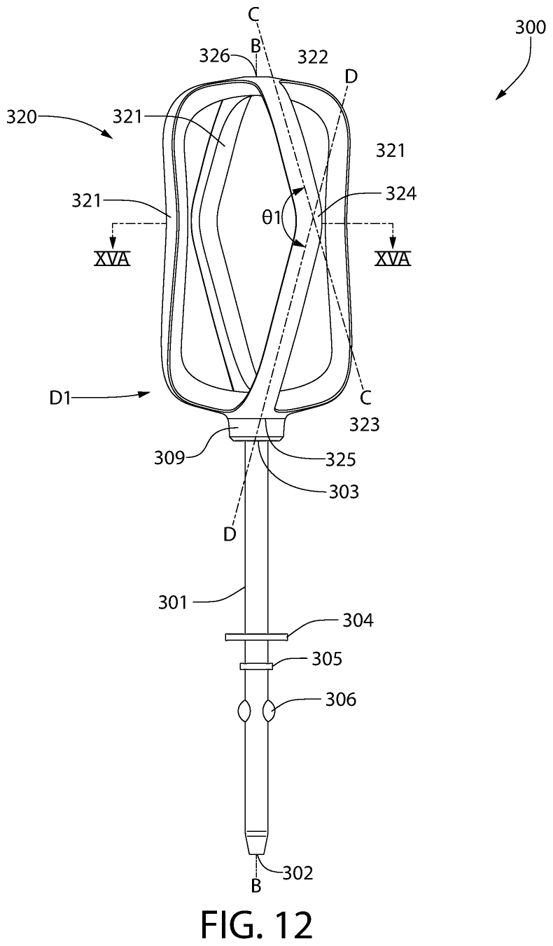

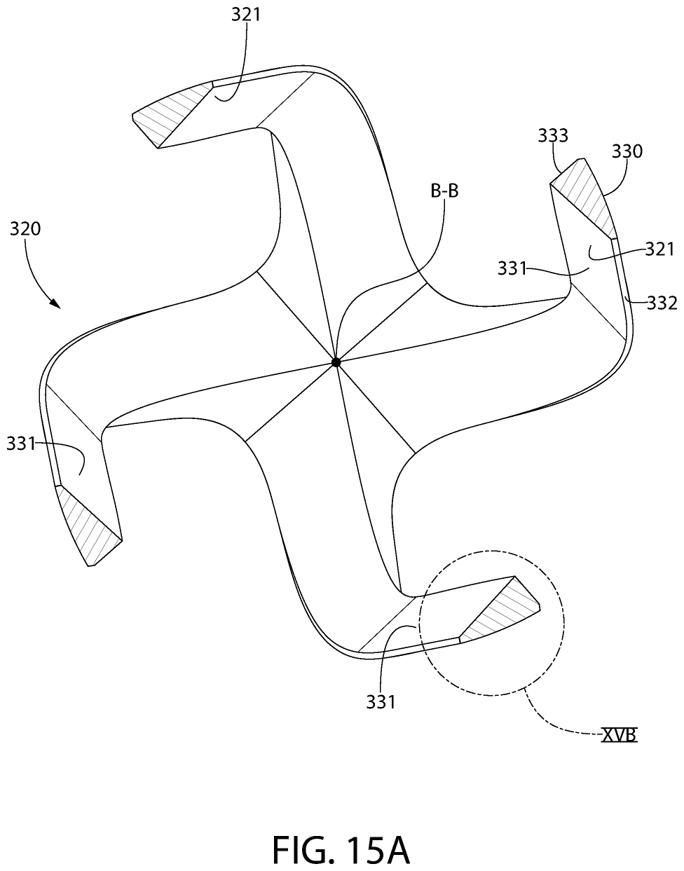

Referring to FIGS. 11-14, the beater attachment 1020d will be further described. It should be appreciated that the beater attachment 1020c is identical to the beater attachment 1020d, except mirrored. Thus, the description of the beater attachment 1020d is entirely applicable to the beater attachment 1020c. The beater attachment 1020c will not be separately described in the interest of brevity, it being understood that the description of the beater attachment 1020d is applicable.

The shaft 301 of the beater attachment 1020d comprises a first end 302 that is configured to attach to a handheld appliance (such as the housing 101 of the handheld appliance 100 described above) and a second end 303 that is opposite the first end 302. The second end 303 may be coupled to the mixing element 320. The shaft 301 may extend from the first end 302 to the second end 303 along a longitudinal axis B-B. The shaft 301 may comprise one or more locking mechanisms 304, 305, 306 that are configured to engage with features of the handheld appliance to facilitate the mechanical engagement between the first end 302 of the shaft 301 and the handheld appliance.

The mixing element 320 is coupled to the second end 303 of the shaft 301. The mixing element 320 is the portion of the beater attachment 1020d that is configured to contact and mix substances, such as food, during use. The mixing element 320 may comprise a bottom end 325, a top end 326, and a plurality of arms 321 extending between the bottom and top ends 325, 326. The plurality of arms 321 surround the longitudinal axis B-B in a circumferentially spaced apart manner. In the exemplified embodiment, the mixing element 320 comprises four of the arms 321. However, more or fewer than four arms could be used in other embodiments, such as three arms, five arms, or the like. In the exemplified embodiment, there is a cylindrical post 309 protruding from the bottom end 325 of the mixing element 320. The cylindrical post 309 may comprise an opening or hole for receiving the second end 303 of the shaft 301 to facilitate the coupling of the mixing element 320 to the shaft 301.

Each of the plurality of arms 321 comprise a first linear portion 322 that extends from the top end 326 of the mixing element 320 downwardly towards the bottom end 325 and a second linear portion 323 that extends upwardly from the bottom end 325 towards the top end 326. The arms 321 further comprise a top portion 327 that extends radially from the first linear portion 322 to the top end 325. The arms 321 further comprise a bottom portion 328 extending radially from the second linear portion 323 to the bottom end 325. The first linear portion 322 extends along a first axis C-C and the second linear portion 323 extends along a second axis D-D. The second axis D-D is angled relative to the first axis C-C. The first and second axes C-C, D-D may intersect to form an “X” shape. The first and second axes C-C, D-D may intersect at an angle Θ1 between 120° and 160°, or more specifically between 130° and 150°. The angle Θ1 may be an obtuse angle. Each of the first and second axes C-C. D-D may be angled relative the longitudinal axis B-B. In an embodiment, the first and second axes C-C, D-D are neither parallel to nor perpendicular to the longitudinal axis B-B. In an embodiment, for each of the arms 321, the first and second linear portions 322, 323 line in a common plane that is substantially parallel to the longitudinal axis B-B.

The first linear portion 322 extends downwardly from the top end 326 in a first circumferential direction D1. The second linear portion 323 extends upwardly from the bottom end 325 in the first circumferential direction D1. The first and second linear portions 322, 323 may be connected together at an apex or vertex 324. In some embodiments, the first and second linear portions 322, 323 connect to form a v-shaped arm. That is, some embodiments each of the arms 321 has a V shape. In certain embodiments, the first and second linear portions 322, 323 of each of the arms 321 are connected to form apexes 324 that face the same circumferential direction. That is, each of the plurality of arms 321 is angled in the same way such that the first linear portion 322 of each arm 321 extends downwardly from the top end 326 in the first circumferential direction D1 and the second linear portions 323 of each arm 321 extends upwardly from the top end 325 in the first circumferential direction D1. The beater attachment 1020c differs from the beater attachment 1020d in that the first and second linear portions of each of the arms extend in a second circumferential direction, which is opposite the first circumferential direction.

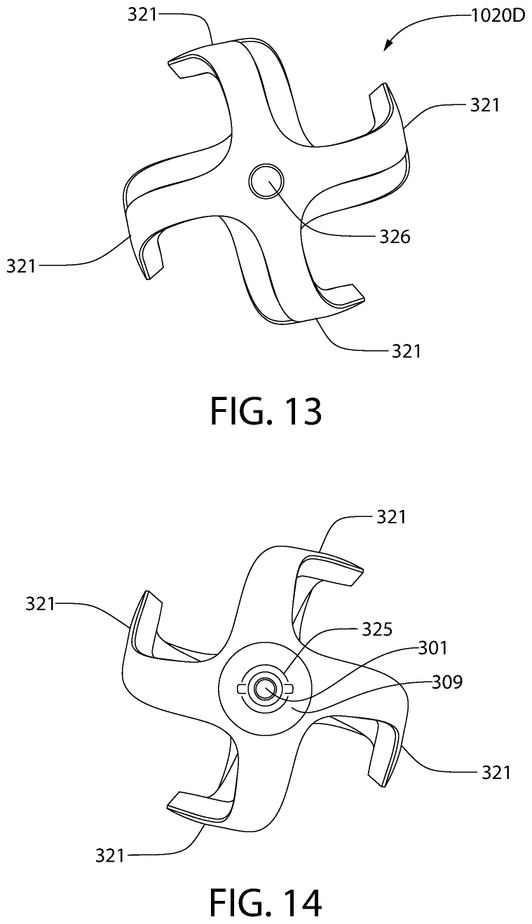

To reiterate, there are two exemplary embodiments of the mixing element. The beater attachment 1020c comprises a first and second linear portion that connect to form an apex such that the apexes all face a clockwise direction when viewed from a top plan view. The beater attachment 1020d comprises the first and second linear portions 322, 323 that connect to form the apex 234 such that the apexes 324 all face a counterclockwise direction when viewed from a top plan view (see FIG. 13). Stated another way, the first and second linear portions 322, 323 of each of the arms 321 extend towards one another (i.e., the first linear portion extends towards the second linear portion 322 and vice versa) in the same circumferential direction (counterclockwise for the beater attachment 1020c and counterclockwise for the beater attachment 1020d).

In the exemplified embodiment, for each of the plurality of arms 321, the apex 324 is located closer to the top end 326 of the mixing element 320 than to the bottom end 325 of the mixing element 320. Thus, in accordance therewith, in the exemplified embodiment the first linear portion 322 of each of the arms 321 has a greater length (measured along its own axis C-C) than the second linear portions 323 of each of the arms 321 (measured along its own axis D-D). The invention is not to be so limited in all embodiments, and in alternative embodiments, the first linear portion 322 may have a greater length than the second linear portion 323, or the first and second linear portions 322, 323 may have the same or similar length. In one embodiment, the mixing element 320 is shown to scale such that the relative sizes of the first and second linear portions 322, 323 are to scale relative to one another.

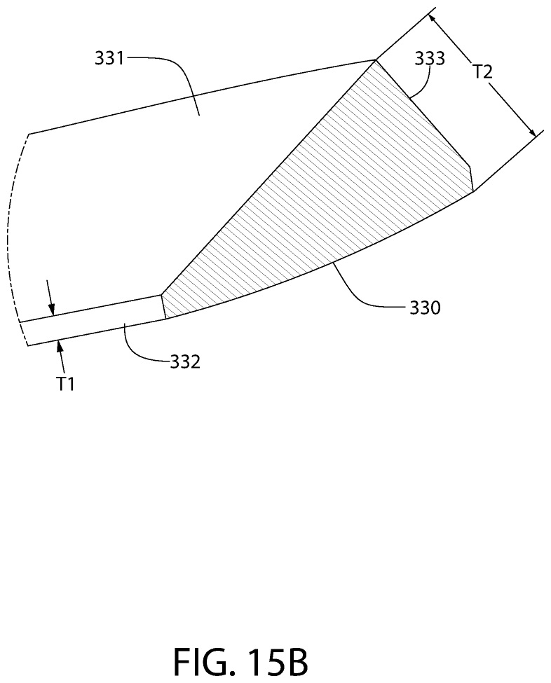

Referring now to FIGS. 15A and 15B, each of the arms 321 comprises a wedge-shaped transverse cross-sectional area. Thus, each of the plurality of arms 321 comprises an outer surface 330 that faces away from the longitudinal axis B-B, an inner surface 331 opposite the outer surface 330 so that the inner surface 331 generally faces the longitudinal axis B-B, a first edge 332, and a second edge 333 opposite the first edge 332. The first and second edges 332, 333 each extend between the outer and inner surfaces 330, 331. The first edge 332 may comprise a first thickness T1 measured between the outer and inner surfaces 330, 331 and the second edge 333 may comprise a second thickness T2 measured between the outer and inner surfaces 330, 331. In the exemplified embodiment, the second thickness T2 is greater than the first thickness T1. The second thickness T2 may be at least twice the first thickness, or at least three times the first thickness, or at least four times the first thickness in various embodiments. In an embodiment, the first thickness T1 may be between 0.5 mm and 1.5 mm. In an embodiment, the second thickness T2 may be between 2 mm and 6 mm, more specifically between 2.5 mm and 5 mm, more specifically between 3.5 mm and 5 mm. When in use, the beater attachment 1020d may be configured to rotate so that the first edge 332 is the leading edge.

In an embodiment, the outer and inner surfaces 330, 331 each have a greater surface area than each of the first and second edges 332, 333.

In some embodiments, the first edge 332 of each of the plurality of arms 321 is concave in a direction of the longitudinal axis B-B and the second edge 333 of each of the plurality of arms 321 is convex in the direction of the longitudinal axis B-B. In certain embodiments, the first edge 332 of each of the plurality of arms 321 faces the second edge 333 of an adjacent one of the plurality of arms 321, and vice versa. That is, the first edge 332 may form the inside of the V-shape formed by the arms 321 and the second edge 333 may form the outside of the V-shape formed by the arms 321.

The beater attachments 1020c, 1020d described herein have a unique shape, which may be splash resistant. The unique shape of the beater attachments 1020c, 1020d may create a vortex that pushes the ingredients down as it turns/rotates. This may reduce the splash that may be generated as the beater attachments 1020c, 1020d mix the ingredients. Due to the large interior space and straight angles of the features of the beater attachments 1020c, 1020d, the ingredients may spin off easily and readily while mixing. For thicker ingredients, it may be easier to remove ingredients with fingers and/or silicone spatulas as compared with conventional beater attachments. The beater attachments 1020c, 1020d may mix ingredients faster and more consistently than conventional beater attachments.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

1. A handheld appliance comprising:
a housing comprising a cavity and an opening that provides a passageway into the cavity;
one or more electronic components located within the cavity of the housing;
a power cord operably coupled to the one or more electronic components, the power cord being configured to transmit power from a power source to the one or more electronic components;
a cord storage compartment coupled to the housing and closing the opening, the cord storage compartment comprising a central support portion, wherein the power cord is configured to be at least partially wrapped around the central support portion; and
wherein the central support portion of the cord storage compartment is movable relative to the housing between: (1) a closed position wherein the central support portion is at least partially located within the cavity of the housing; and (2) an open position wherein the central support portion protrudes from the housing to allow adjustments to an amount of the power cord that is wrapped around the central support portion.

2. The handheld appliance according to claim 1 wherein the housing comprises a rim that surrounds the opening, and wherein the cord storage compartment comprises a front cover that is coupled to the central support portion, wherein the front cover of the cord storage compartment contacts the rim of the housing when the cord storage compartment is in the closed position.

3. The handheld appliance according to claim 2 wherein the central support portion of the cord storage compartment comprises a first end, a second end, and an outer surface upon which the power cord is configured to be wrapped, wherein the front cover is coupled to the first end of the central support structure and protrudes radially beyond the outer surface of the central support portion of the cord storage compartment.

4. The handheld appliance according to claim 1 wherein the cord storage compartment comprises:
a fixed component that is fixedly coupled to the housing with at least a portion of the fixed component positioned within the cavity of the housing; and
a cover plate that is movable relative to the housing and relative to the fixed component between the closed and open positions, the cover plate comprising the central support portion of the cord storage compartment.

5. The handheld appliance according to claim 4 wherein the fixed component comprises a first stopper feature and the cover plate comprises a second stopper feature that engages the first stopper feature of the fixed component to prevent the cover plate from becoming detached from the fixed component.

6. The handheld appliance according to claim 4 further comprising:
the fixed component comprising a plate portion having a lower surface, a sidewall portion extending from the lower surface of the plate portion to a distal end, and a flange portion protruding inwardly from the distal end of the sidewall portion; and
wherein the central support portion of the cover plate comprises an outer surface upon which the power cord is configured to be wrapped and an inner surface opposite the outer surface that defines an interior space, the cover plate comprising a post located within the interior space, the post terminating in a post flange that engages the flange portion of the fixed component to prevent the cover plate from becoming detached from the fixed component.

7. The handheld appliance according to claim 1 wherein when the cord storage compartment is in the closed state, the cord storage compartment and the housing form an interface, and further comprising a notch located along the interface for receiving a portion of the power cord so that a distal portion of the power cord can protrude from the housing when the cord storage compartment is in the closed state.

8. The handheld appliance according to claim 1, wherein the handheld appliance is a hand mixer and the one or more electronic components comprises a motor.

9. The handheld appliance according to claim 8 wherein the housing comprises a working surface portion having a first opening and a second opening each of which is configured to receive a portion of a mixer attachment to facilitate coupling the mixer attachment to the housing.

10. The handheld appliance according to claim 9 further comprising:
a third opening in the working surface portion of the housing that is configured to receive a post of a splashguard; and
a closure member coupled to the housing and configured to close the third opening when the splashguard is not coupled to the housing.

11. A handheld appliance comprising:
a housing comprising a cavity and an opening that provides a passageway into the cavity;
one or more electronic components located within the cavity of the housing;
a power cord operably coupled to the one or more electronic components, the power cord being configured to transmit power from a power source to the one or more electronic components;
a cord storage compartment coupled to the housing and closing the opening, wherein the power cord is capable of being wrapped around the cord storage compartment;
wherein the at least a portion of the cord storage compartment is movable relative to the housing between: (1) a closed position wherein portions of the power cord that are wrapped around the cord storage compartment are inaccessible to a user; and (2) an open position wherein the portions of the power cord that are wrapped around the cord storage compartment are accessible to the user.

12. The handheld appliance according to claim 11 wherein the housing comprises a rim that surrounds the opening, and wherein the cord storage compartment comprises a front cover that is coupled to the central support portion, wherein the front cover of the cord storage compartment contacts the rim of the housing when the cord storage compartment is in the closed position.

13. The handheld appliance according to claim 11 wherein the central support portion of the cord storage compartment comprises a first end, a second end, and an outer surface upon which the power cord is configured to be wrapped, wherein the front cover is coupled to the first end of the central support structure and protrudes radially beyond the outer surface of the central support portion of the cord storage compartment.

14. The handheld appliance according to claim 11 wherein the cord storage compartment comprises:
a fixed component that is fixedly coupled to the housing with at least a portion of the fixed component positioned within the cavity of the housing; and
a cover plate that is movable relative to the housing and relative to the fixed component between the closed and open positions, the cover plate comprising the central support portion of the cord storage compartment.

15. The handheld appliance according to claim 14 wherein the fixed component comprises a first stopper feature and the cover plate comprises a second stopper feature that engages the first stopper feature of the fixed component to prevent the cover plate from becoming detached from the fixed component.

16. The handheld appliance according to claim 14 further comprising:
the fixed component comprising a plate portion having a lower surface, a sidewall portion extending from the lower surface of the plate portion to a distal end, and a flange portion protruding inwardly from the distal end of the sidewall portion; and
wherein the central support portion of the cover plate comprises an outer surface upon which the power cord is configured to be wrapped and an inner surface opposite the outer surface that defines an interior space, the cover plate comprising a post located within the interior space, the post terminating in a post flange that engages the flange portion of the fixed component to prevent the cover plate from becoming detached from the fixed component.

17. The handheld appliance according to claim 11 wherein when the cord storage compartment is in the closed state, the cord storage compartment and the housing form an interface, and further comprising a notch located along the interface so that for receiving a portion of the power cord so that a distal portion of the power cord can protrude from the housing when the cord storage compartment is in the closed state.

18. The handheld appliance according to claim 11, wherein the handheld appliance is a hand mixer and the one or more electronic components comprises a motor.

19. The handheld appliance according to claim 18 wherein the housing comprises a working surface portion having a first opening and a second opening each of which is configured to receive a portion of a mixer attachment to facilitate coupling the mixer attachment to the housing.

20. The handheld appliance according to claim 19 further comprising:
a third opening in the working surface portion of the housing that is configured to receive a post of a splashguard; and
a closure member coupled to the housing and configured to close the third opening when the splashguard is not coupled to the housing.

21.-40. (canceled)
